(19) United States
(12) Patent Application Publication
(10) Pub. No.: US 2024/0381313 A1
(43) Pub. Date: Nov. 14, 2024

(54) PAGING IN A MULTIPLE UNIVERSAL SUBSCRIBER IDENTITY MODULE DEVICE

(71) Applicant: Nokia Technologies Oy, Espoo (FI)

(72) Inventors: Srinivasan SELVAGANAPATHY, Bangalore (IN); Faranaz SABOURI-SICHANI, Aalborg (DK); Frank FREDERIKSEN, Aalborg (DK); Laura Luque SANCHEZ, Aalborg (DK); Aby KANNEATH ABRAHAM, Bangalore (IN)

(21) Appl. No.: 18/553,059

(22) PCT Filed: Mar. 28, 2022
(86) PCT No.: PCT/EP2022/058064

§ 371 Date: Sep. 28, 2023

(30) Foreign Application Priority Data
Mar. 31, 2021 (IN) 202141015053

(51) Int. Cl. H04W 68/02; H04W 76/27; H04W 88/06

(52) U.S. Cl. CPC H04W 68/02; H04W 76/27; H04W 88/06

(57) ABSTRACT

An apparatus comprising means for: enabling paging collision avoidance in a device with multiple subscriptions comprising at least a first subscription configured to enable a first user equipment at the device and a second subscription configured to enable a second user equipment at the device by: determining one or more expected paging collisions that will occur between the first user equipment at the device and at least the second user equipment at the device when the first user equipment and second user equipment are not in radio connected mode and at least one of the first user equipment and second user equipment are in radio inactive mode; determining assistance information, based, at least in part, on the determined one or more expected paging collisions; transmitting the assistance information to at least one network node; and receiving paging configuration information, the paging configuration information determined based, at least in part, on the assistance information.

### TECHNOLOGICAL FIELD

Embodiments of the present disclosure relate to paging. Some relate to paging in a multiple universal subscriber identity module device.

### BACKGROUND

A wireless network comprises a plurality of network nodes including terminal nodes, access nodes. Communication between the terminal nodes and the access nodes is wireless.

In some circumstances, it may be desirable to modify or enhance how paging is configured in the wireless network.

### BRIEF SUMMARY

According to various, but not necessarily all, embodiments there is provided an apparatus comprising means for:
enabling paging collision avoidance in a device with multiple subscriptions comprising at least a first subscription configured to enable a first user equipment at the device and a second subscription configured to enable a second user equipment at the device by:
determining one or more expected paging collisions that will occur between the first user equipment at the device and at least the second user equipment at the device when the first user equipment and second user equipment are not in radio connected mode and at least one of the first user equipment and second user equipment are in radio inactive mode;
determining assistance information, based, at least in part, on the determined one or more expected paging collisions;
transmitting the assistance information to at least one network node; and
receiving paging configuration information, the paging configuration information determined based, at least in part, on the assistance information.

In some examples, determining one or more expected paging collisions comprises determining one or more expected paging collisions that will occur between the first user equipment at the device and the second user equipment at the device when the first user equipment is in radio inactive mode and the second user equipment is in radio idle mode.

In some examples, determining one or more expected paging collisions comprises using radio access network paging cycle information.

In some examples, the assistance information comprises at least one of: an indication of one or more preferred paging cycles, one or more offsets and information configured to assist in modification of a user equipment identifier at the device.

In some examples, transmitting the assistance information comprises transmitting the assistance information via at least one radio resource control signalling message.

In some examples, receiving paging configuration information comprises receiving paging configuration information via a message configured to move a user equipment from radio connected state to radio idle state or radio inactive state

In some examples, transmitting the assistance information comprises transmitting the assistance information to at least one core network node.

In some examples, receiving paging configuration information comprises receiving at least one user equipment identifier.

In some examples, the means are configured to:
receive at least one message, wherein determining one or more expected paging collisions comprises determining one or more expected paging collisions based, at least in part, on the received at least one message.

In some examples, determining assistance information comprises determining assistance information based, at least in part, on information of one or more neighbouring cells.

In some examples, the means are configured to process the received paging configuration information.

In some examples, the means comprises
at least one processor; and
at least one memory including computer program code, the at least one memory and computer program code configured to, with the at least one processor, cause performance of the apparatus.

According to various, but not necessarily all, embodiments, there is provided a method comprising:
enabling paging collision avoidance in a device with multiple subscriptions comprising at least a first subscription configured to enable a first user equipment at the device and a second subscription configured to enable a second user equipment at the device by:
determining one or more expected paging collisions that will occur between the first user equipment at the device and at least the second user equipment at the device when the first user equipment and second user equipment are not in radio connected mode and at least one of the first user equipment and second user equipment are in radio inactive mode;
determining assistance information, based, at least in part, on the determined one or more expected paging collisions;
transmitting the assistance information to at least one network node; and
receiving paging configuration information, the paging configuration information determined based, at least in part, on the assistance information.

In some examples, determining one or more expected paging collisions comprises determining one or more expected paging collisions that will occur between the first user equipment at the device and the second user equipment at the device when the first user equipment is in radio inactive mode and the second user equipment is in radio idle mode.

In some examples, determining one or more expected paging collisions comprises using radio access network paging cycle information.

In some examples, the assistance information comprises at least one of: an indication of one or more preferred paging cycles, one or more offsets and information configured to assist in modification of a user equipment identifier at the device.

In some examples, transmitting the assistance information comprises transmitting the assistance information via at least one radio resource control signalling message.

In some examples, receiving paging configuration information comprises receiving paging configuration information via a message configured to move a user equipment from radio connected mode to radio idle mode or radio inactive mode.

In some examples, transmitting the assistance information comprises transmitting the assistance information to at least one core network node.

In some examples, receiving paging configuration information comprises receiving at least one user equipment identifier.

In some examples, the method comprising:
receiving at least one message, wherein determining one or more expected paging collisions comprises determining one or more expected paging collisions based, at least in part, on the received at least one message.

In some examples, determining assistance information comprises determining assistance information based, at least in part, on information of one or more neighbouring cells.

In some examples, the method comprising processing the received paging configuration information.

According to various, but not necessarily all, embodiments there is provided a computer program comprising instructions for causing an apparatus to perform at least the following:
enabling paging collision avoidance in a device with multiple subscriptions comprising at least a first subscription configured to enable a first user equipment at the device and a second subscription configured to enable a second user equipment at the device by:
determining one or more expected paging collisions that will occur between the first user equipment at the device and at least the second user equipment at the device when the first user equipment and second user equipment are not in radio connected mode and at least one of the first user equipment and second user equipment are in radio inactive mode;
determining assistance information, based, at least in part, on the determined one or more expected paging collisions;
transmitting the assistance information to at least one network node; and
receiving paging configuration information, the paging configuration information determined based, at least in part, on the assistance information.

In some examples, determining one or more expected paging collisions comprises determining one or more expected paging collisions that will occur between the first user equipment at the device and the second user equipment at the device when the first user equipment is in radio inactive mode and the second user equipment is in radio idle mode.

In some examples, determining one or more expected paging collisions comprises using radio access network paging cycle information.

In some examples, the assistance information comprises at least one of: an indication of one or more preferred paging cycles, one or more offsets and information configured to assist in modification of a user equipment identifier at the device.

In some examples, transmitting the assistance information comprises transmitting the assistance information via at least one radio resource control signalling message.

In some examples, receiving paging configuration information comprises receiving paging configuration information via a message configured to move a user equipment from radio connected mode to radio idle mode or radio inactive mode.

In some examples, transmitting the assistance information comprises transmitting the assistance information to at least one core network node.

In some examples, receiving paging configuration information comprises receiving at least one user equipment identifier.

In some examples, the computer program comprising instructions for causing an apparatus to perform, at least:
receiving at least one message, wherein determining one or more expected paging collisions comprises determining one or more expected paging collisions based, at least in part, on the received at least one message.

In some examples, determining assistance information comprises determining assistance information based, at least in part, on information of one or more neighbouring cells.

In some examples, the computer program comprising instructions for causing an apparatus to perform, at least: processing the received paging configuration information.

In some examples, the computer program stored on a non-transitory computer readable medium.

According to various, but not necessarily all, embodiments there is provided an apparatus comprising means for:
receiving assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determining paging configuration information based, at least in part, on the received assistance information; and
transmitting the determined paging configuration information to configure paging at the multiple subscription device.

In some examples, the assistance information comprises information configured to assist in avoiding one or more expected paging collisions that will occur between the first user equipment at the device and at least the second user equipment at the device when the first user equipment is in radio inactive mode and the second user equipment is in radio idle mode.

In some examples, the assistance information comprises at least one of: an indication of one or more preferred paging cycles, one or more offsets and information configured to assist in modification of a user equipment identifier at the device.

In some examples, receiving the assistance information comprises receiving the assistance information via at least one radio resource control signalling message.

In some examples, transmitting the determined paging configuration information comprises transmitting paging configuration information via a message configured to move a user equipment from radio connected mode to radio idle mode or radio inactive mode.

In some examples, the apparatus is located at a core network node.

In some examples, transmitting the determined paging configuration information comprises transmitting at least one user equipment identifier.

In some examples, the means comprises
at least one processor; and
at least one memory including computer program code, the at least one memory and computer program code configured to, with the at least one processor, cause performance of the apparatus.

According to various, but not necessarily all, embodiments there is provided a method comprising:
receiving assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determining paging configuration information based, at least in part, on the received assistance information; and
transmitting the determined paging configuration information to configure paging at the multiple subscription device.

In some examples, the assistance information comprises information configured to assist in avoiding one or more expected paging collisions that will occur between the first user equipment at the device and at least the second user equipment at the device when the first user equipment is in radio inactive mode and the second user equipment is in radio idle mode.

In some examples, the assistance information comprises at least one of: an indication of one or more preferred paging cycles, one or more offsets and information configured to assist in modification of a user equipment identifier at the device.

In some examples, receiving the assistance information comprises receiving the assistance information via at least one radio resource control signalling message.

In some examples, transmitting the determined paging configuration information comprises transmitting paging configuration information via a message configured to move a user equipment from radio connected mode to radio idle mode or radio inactive mode.

In some examples, the apparatus is located at a core network node.

In some examples, transmitting the determined paging configuration information comprises transmitting at least one user equipment identifier.

According to various, but not necessarily all, embodiments there is provided a computer program comprising instructions for causing an apparatus to perform at least the following:
receiving assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determining paging configuration information based, at least in part, on the received assistance information; and
transmitting the determined paging configuration information to configure paging at the multiple subscription device.

In some examples, the assistance information comprises information configured to assist in avoiding one or more expected paging collisions that will occur between the first user equipment at the device and at least the second user equipment at the device when the first user equipment is in radio inactive mode and the second user equipment is in radio idle mode.

In some examples, the assistance information comprises at least one of: an indication of one or more preferred paging cycles, one or more offsets and information configured to assist in modification of a user equipment identifier at the device.

In some examples, receiving the assistance information comprises receiving the assistance information via at least one radio resource control signalling message.

In some examples, transmitting the determined paging configuration information comprises transmitting paging configuration information via a message configured to move a user equipment from radio connected mode to radio idle mode or radio inactive mode.

In some examples, the apparatus is located at a core network node.

In some examples, transmitting the determined paging configuration information comprises transmitting at least one user equipment identifier.

In some examples, the computer program stored on a non-transitory computer readable medium.

According to various, but not necessarily all, embodiments there is provided an apparatus comprising
at least one processor; and
at least one memory including computer program code;
the at least one memory and the computer program code configured to, with the at least one processor, cause the apparatus at least to perform at least a part of one or more methods disclosed herein.

According to various, but not necessarily all, embodiments there is provided an apparatus comprising means for performing at least part of one or more methods disclosed herein.

According to various, but not necessarily all, embodiments there is provided examples as claimed in the appended claims.

The description of a function and/or action should additionally be considered to also disclose any means suitable for performing that function and/or action.

### BRIEF DESCRIPTION

Some examples will now be described with reference to the accompanying drawings in which:

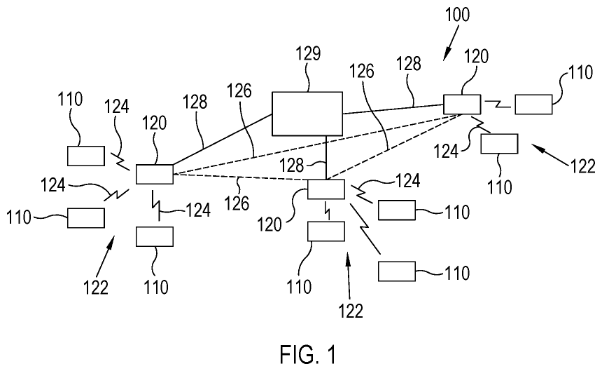

FIG. 1 shows an example of the subject matter described herein;

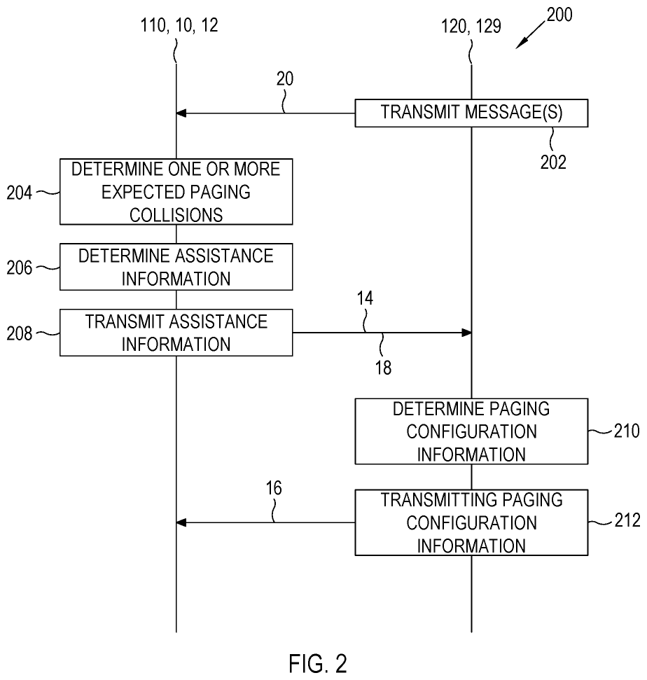

FIG. 2 shows another example of the subject matter described herein;

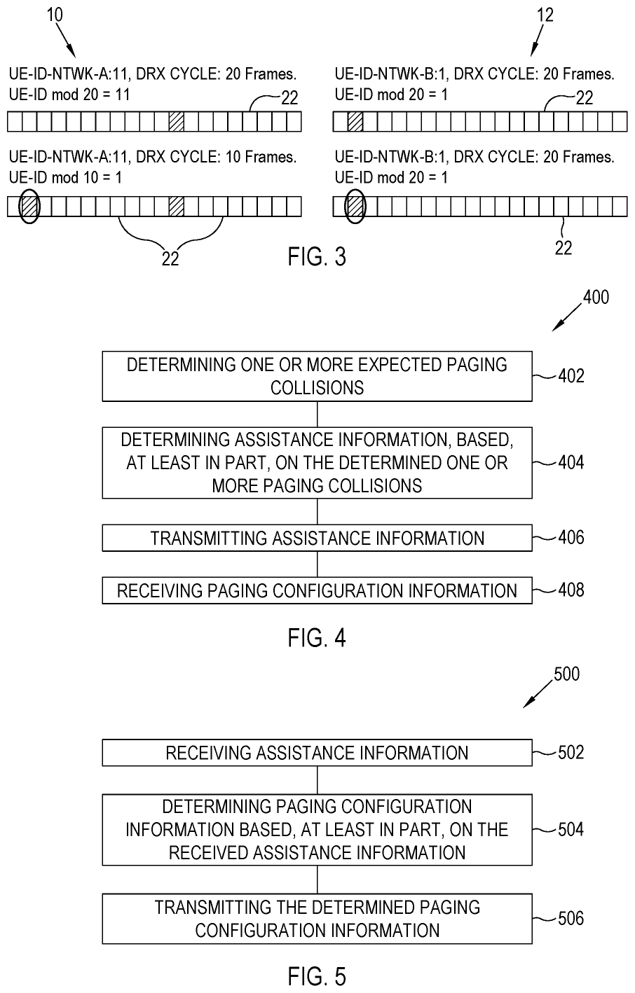

FIG. 3 shows another example of the subject matter described herein;

FIG. 4 shows another example of the subject matter described herein;

FIG. 5 shows another example of the subject matter described herein;

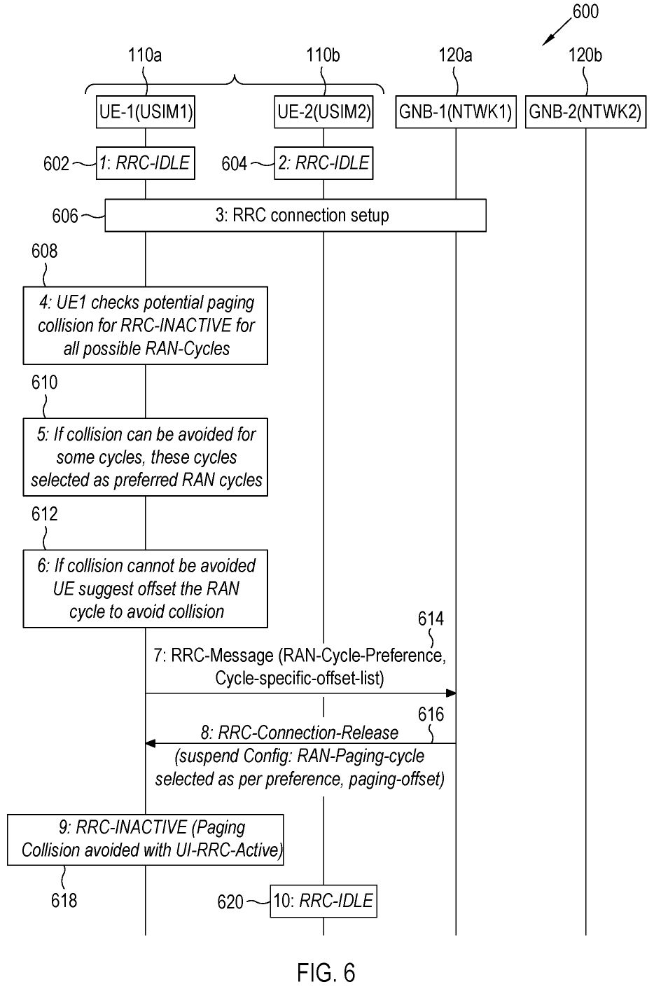

FIG. 6 shows another example of the subject matter described herein;

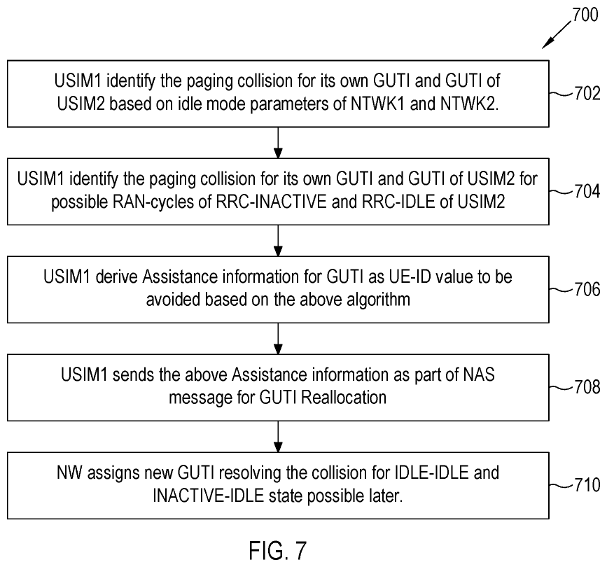

FIG. 7 shows another example of the subject matter described herein;

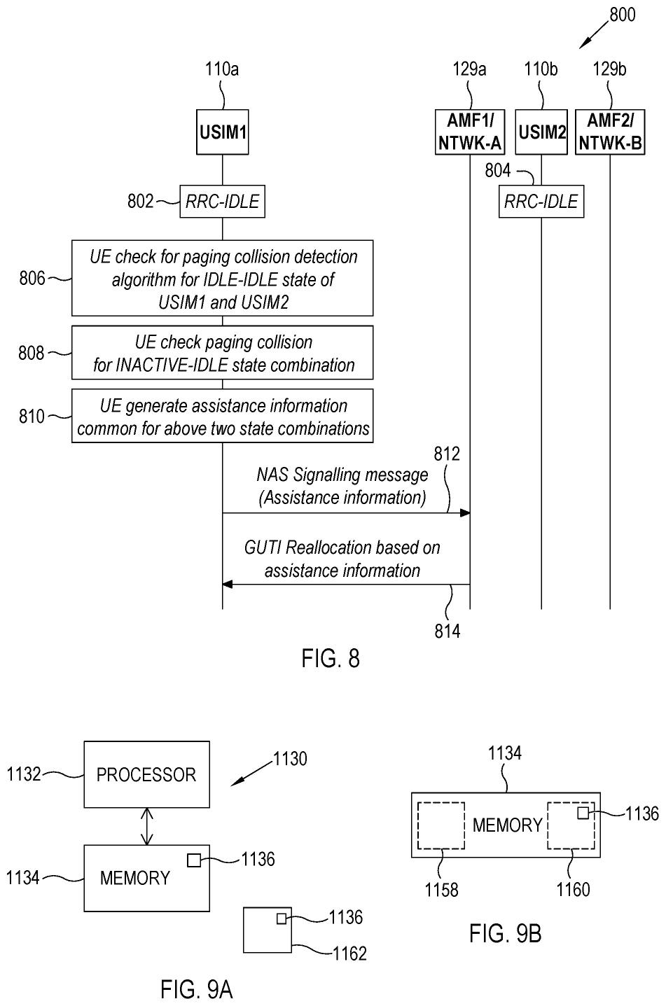

FIG. 8 shows another example of the subject matter described herein;

FIG. 9A shows another example of the subject matter described herein; and

FIG. 9B shows another example of the subject matter described herein.

### ABBREVIATIONS

3GPP—3rd Generation Partnership Project
UE—User Equipment
SIM—Subscriber Identification Module
USIM—Universal Subscriber Identification Module
MUSIM—Multiple Universal Subscriber Identification Module
IMSI—International Mobile Subscriber Identity
EPS—Evolved Packet System
TMSI—Temporary Mobile Subscriber Identity
GUTI—Global Unique Temporary Identifier
RRC—Radio Resource Control
NAS—Non Access Stratum
DRX—Discontinuous Reception
RAN—Radio Access Network
MME—Mobile Management Entity
AMF—Access and Mobility Management Function
NWTK—Network

### Definitions

RRC_CONNECTED—A state where UE has dedicated radio connection for active data transmission.

RRC_INACTIVE—A state where UE monitors for paging and needs to establish radio connection with gNodeB (gNB) to start data transmission. In this state the radio-resource related configuration is stored at UE for quick resuming of RRC connection. Likewise, the UE context is not released at the network. This state is maintained between UE and gNB (base station).

RRC_IDLE—A state where UE monitors for paging and needs to establish radio connection to start data transmission. As there is no radio-resource configuration stored the RRC connection setup procedure is used to configure radio resources.

RRCConnectionRelease message: Radio Resource Control Message from the network for moving the UE from CONNECTED state to either IDLE or INACTIVE state.

NAS signalling message: Signalling message between UE and core-network element. In 5G corresponding core-network element it is called Access and Mobility Management Function (AMF).

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The one or more terminal nodes 110 may, in some examples, communicate with each other.

The network 100 may be a cellular network comprising a plurality of cells 122 at least one served by an access node 120. In this example, the interface between the terminal nodes 110 and an access node 120 defining a cell 122 is a wireless interface 124.

The access node(s) 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations (for example, gNBs).

Functionality of a base station may be distributed between a central unit (CU), for example a gNB-CU, and one or more distributed units (DU), for example gNB-DUs.

In the particular example illustrated the network 100 is an Evolved Universal Terrestrial Radio Access network (E-UTRAN). The E-UTRAN consists of E-UTRAN NodeBs (eNBs), providing the E-UTRA user plane and control plane (for example, RRC) protocol terminations towards the UE. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs), providing the user plane and control plane (for example, RRC) protocol terminations towards the UE. The gNBs are interconnected with each other by means of an X2/Xn interface 126. The gNBs are also connected by means of the N2 interface 128 to the Access and Mobility management Function (AMF).

In examples, the network 100 can comprise a combination of E-UTRAN and NG-RAN.

In examples, a terminal node 110 can monitor for paging signals. Paging configuration at a terminal node 110 can be configured by the network, for example by an access node 120 or core node 129.

Some examples relate to a 3GPP network.

FIG. 2 illustrates an example of a method 200.

In examples, FIG. 2 can be considered to illustrate a plurality of methods. For example, FIG. 2 illustrates one or more actions at a plurality of actors/entities. In examples, FIG. 2 can be considered to illustrate a plurality of methods performed by the individual actors/entities.

One or more of the features discussed in relation to FIG. 2 can be found in one or more of the other FIGS. During discussion of FIG. 2, reference will be made to other FIGS for the purposes of explanation.

In the example of FIG. 2, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of a network 100 as described in relation to FIG. 1.

In the illustrated example, a terminal node 110 and a network node transmit and/or receive one or more signals and/or one or more messages.

In examples, communications and/or transmissions between elements illustrated in FIG. 2 can proceed via any number of intervening elements, including no intervening elements.

In examples, method 200 and/or parts of method 200 can be considered a method of configuring paging at a terminal node 110 and/or a method of controlling paging at a terminal node 110.

In some examples, method 200 and/or parts of method 200 can be considered a method of avoiding paging collision and/or a method of preventing paging collision.

In some examples, the network node is/comprises an access node 120, such as a gNodeB (gNB).

In some examples, the network node is/comprises a core node 129.

In examples, the terminal node 110 can be considered a device.

In some examples, there terminal node 110 is a device with multiple subscriptions comprising at least a first subscription configured to enable a first user equipment (UE1) at the device and a second subscription configured to enable a second user equipment (UE2) at the device. However, in examples, the terminal node 110 can have any suitable number of subscriptions configured to enable any suitable number of UEs at the terminal node 110.

Any suitable subscription can be used. In examples, a subscription can be a 3GPP subscription, a 3GPP2 subscription, an Enhanced Support of Non-Public Networks (eNPN) subscription and so on.

In some examples, the terminal node 110 is a multiple SIM device and/or a multiple USIM (MUSIM) device comprising a plurality of SIMs/USIMs configured to enable a plurality of UEs at the terminal node 110.

Accordingly, in examples, the terminal node 110 is a MUSIM device comprising at least a first USIM configured to enable a first UE (UE1) at the device and a second USIM configured to enable a second UE (UE2) at the device. However, in examples, the terminal node 110 can have any suitable number of USIMs configured to enable any suitable number of UEs at the terminal node 110.

In examples, the terminal node 110 can be considered a device configured for multiple USIM operation.

In examples, a subscription and/or USIM can be considered to enable and/or configure and/or provide a UE at the terminal node 110.

In examples, enabling and/or configuring and/or providing a UE at the terminal node 110 can be considered enabling and/or configuring and/or providing UE functionality at the terminal node 110.

In examples, enabling and/or configuring and/or providing a UE at the terminal node 110 can be considered enabling and/or configuring and/or providing the terminal node 110 to function as a UE.

For example, a terminal node 110 configured with multiple subscriptions and/or multiple USIMs is enabled to receive paging for each of the registered subscriptions and/or USIMs.

Accordingly, in examples, enabling a first UE at the terminal node 110 can be considered enabling the terminal node 110 to function as a first UE.

Accordingly, in examples, enabling a second UE at the terminal node 110 can be considered enabling the terminal node 110 to function as a second UE.

Accordingly, in examples, enabling a first and second UE at the terminal node 110 can be considered enabling the terminal node 110 to function as a first UE and also as a second UE.

In examples, the subscriptions at the terminal node 110 and/or USIMS at the terminal node 110 and/or UEs enabled at the terminal node 110 have at least one associated identifier. For example, a first subscription and/or first USIM and/or first UE (UE1) enabled at the terminal node 110 has an associated identifier, a second subscription and/or USIM and/or UE (UE2) enabled at the terminal node 110 has a different associated identifier and so on.

Any suitable identifier(s) can be used. For example, International Mobile Subscriber Identities (IMSI) in case of evolved packet system (EPS) or Subscription Permanent Identifier (SUPI) in case of 5G system.

In examples, the subscriptions at the terminal node 110 and/or USIMS at the terminal node 110 and/or UEs enabled at the terminal node 110 can be assigned a temporary identifier such as Temporary Mobile Subscriber Identity (TMSI) or a Global Unique Temporary Identifier (GUTI) and so on.

Accordingly, in examples, from the point of view of the network, the terminal node 110 represents a plurality of UEs having different associated identifiers.

In examples, a paging configuration for a UE can be based, at least in part, on one or more identifiers associated with a subscription and/or USIM and/or UE enabled at the terminal node.

In examples, the plurality of subscriptions and/or USIMS and/or UEs enabled at the terminal node 110 are associated with one or more networks.

In some examples, one or more subscriptions and/or USIMS and/or UEs enabled at the terminal node 110 can be associated with one or more different networks.

In examples, a first subscription and/or USIM and/or UE (UE1) enabled at the terminal node 110 is associated with a first network and a second subscription and/or USIM and/or UE (UE2) enabled at the terminal node 110 is associated with a second, different network.

Accordingly, in examples, the terminal node 110 can be considered a MUSIM device comprising at least a first USIM configured to enable a first UE (UE1) associated with a first network and a second USIM configured to enable a second UE (UE2) associated with a second, different network.

In examples, different network nodes can be associated with different networks. See, for example, FIG. 6.

In examples, the receiving capability and/or receiving configuration of the terminal node 110 is restricted and/or limited compared to the number of subscriptions and/or USIMs and/or UEs enabled at the terminal node 110.

In some examples, the receiving capability and/or configuration of the terminal node 110 can be considered to be restricted and/or limited compared to the number of different networks associated with the subscriptions and/or USIMs and/or UEs enabled at the terminal node 110.

For example, the terminal node 110 can have enabled UEs associated with a first network and second, different network but be configured to receive from one network at a time.

Similarly, the terminal node 110 can have enabled UEs associated with three different networks but be configured to receive from one or two different networks at a time and so on.

The terminal node 110 having restricted and/or limited receiving capability compared to the number of associated networks can cause problems in relation to paging collisions.

A paging collision can be considered a collision for paging monitoring.

A paging collision can be considered an at least partial overlapping of paging monitoring occasions of multiple subscriptions and/or USIMs and/or UEs enabled at the terminal node 110.

Additionally, or alternatively, a paging collision can be considered an occurrence of paging monitoring occasions of multiple subscriptions and/or USIMs and/or UEs enabled at the terminal node 110 at substantially the same time.

For example, a paging collision can be considered to occur when a paging monitoring occasion for a first UE (UE1) enabled at the terminal node 110 occurs/is scheduled to occur in at least a partially overlapping time with a paging monitoring occasion for a second UE (UE2). UE1 and UE2 can be associated with different or same networks.

By way of example, reference is made to FIG. 3.

FIG. 3 shows examples of DRX cycles 22 for a first UE 10 (UE1), on the left in FIG. 3, and a second UE 12 (UE2), on the right in FIG. 3. The first and second UEs 10, 12 are UEs of a MUSIM device.

The upper portion of FIG. 3 shows DRX cycles 22 for UE1 and UE2 in radio idle state/mode. In the example of FIG. 3, the DRX cycles 22 of UE1 and UE2 in radio idle state/mode cover 20 frames.

The paging occasions of the DRX cycles 22 in the example of FIG. 3 are indicated by the shaded frame. It can be seen that in the upper portion of FIG. 3 that the paging occasions of UE1 and UE2 in radio idle mode do not overlap and therefore a paging collision does not occur for the current configurations of UE1 and UE2.

In the lower portion of the example of FIG. 3, UE2 remains in radio idle mode. However, UE1 is now in radio inactive mode which has changed the DRX cycle 22 and paging occasions of UE1.

In the example of FIG. 3, the DRX cycle 22 of UE1 in radio inactive mode covers 10 frames and, as indicated by the circled frames, there is an overlap between a paging occasion of UE1 in radio inactive mode and the unchanged paging occasion of UE2 in radio idle mode.

Therefore, a paging collision can be determined to occur between UE1 in radio inactive mode and UE2 in radio idle mode with the current configurations of UE1 and UE2.

Referring back to FIG. 2, in examples, method 200 and/or parts of method 200 can be considered a method 200 of enabling paging collision avoidance in a device with multiple subscriptions comprising at least a first subscription configured to enable a first user equipment 10 at the device and a second subscription configured to enable a second user equipment 12 at the device.

At block 202, method 200 comprises transmitting at least one message 20.

In the illustrated example, the location of the blocks indicates the entity performing the action(s). For example, in FIG. 2, block 202 is performed at and/or by the network node, which can be an access node 120 or a core node 129.

As FIG. 2 illustrates one or more actions of transmission, FIG. 2 also illustrates the corresponding receiving feature(s)/action(s) and vice versa.

For example, from the point of view of the terminal node 110, block 202 can be considered to illustrate receiving at least one message 20.

This is illustrated in the example of FIG. 2, by the arrow pointing from block 202 to the line representing the terminal node 110.

In examples, the at least one message 20 can comprise information to inform/request the terminal node 110, and/or one or more UEs enabled at the terminal node 110, to provide assistance information 14 for paging collision avoidance.

In some examples, the at least one message 20 can comprise information to inform/request the terminal node 110, and/or one or more UEs enabled at the terminal node 110, to provide assistance information 14 common for radio idle mode, such as RRC_IDLE mode, and radio inactive mode, such as RRC_INACTIVE mode, for collision avoidance.

In some examples, the at least one message 20 can comprise information to request and/or trigger the terminal node 110, and/or one or more UEs enabled at the terminal node 110, to provide assistance information.

The at least one message can be any suitable message(s) having any suitable form. For example, the network can configure the behavior via at least one flag in one or more Non-Access Stratum (NAS) message such as Registration Accept or TAU-Accept.

At block 204, method 200 comprises determining one or more expected paging collisions that will occur between the first UE 10 at the terminal node 110 and at least the second UE at the terminal node 110 when the first UE 10 and second UE 12 are not in radio connected mode and at least one of the first UE 10 and second UE 12 are in radio inactive mode.

In examples, block 204 can be considered to comprise determining one or more expected paging collisions between a plurality of subscriptions at the terminal node 110.

In examples, block 204 can be considered to comprise determining one or more expected paging collisions between a plurality of USIMs at the terminal node 110.

In examples, block 204 can be considered to comprise determining one or more expected paging collisions between a plurality of UEs enabled at the terminal node 110.

As used herein, the term “determining” (and grammatical variants thereof) can include, not least: calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also, “determining” can include resolving, selecting, choosing, establishing, and the like.

A radio connected mode, a radio idle mode and/or a radio inactive mode can comprise/be any suitable mode of a UE at the terminal node 110.

For example, a radio connected mode can be a mode where a UE has a dedicated radio connection for active data transmission.

For example, a radio inactive mode can be a mode where a UE monitors for paging and has to establish a radio connection to start data transmission. In a radio inactive mode, a radio-resource related configuration is stored at a UE for resuming of a radio connection, such as an RRC connection.

For example, a radio idle mode can be a mode where a UE monitors for paging and has to establish a radio connection to start data transmission. In this mode, a radio connection procedure, such as an RRC connection procedure, is used to configure radio resources.

A radio connected mode can be an RRC_CONNECTED mode. A radio inactive mode can be an RRC_INACTIVE mode. A radio idle mode can be an RRC_IDLE mode.

In examples, a radio mode can be considered a radio state.

In examples, one or more expected paging collisions can be determined with regard to a UE at the terminal node 110 in radio inactive mode and at least another UE at the terminal node 110 in radio idle and/or radio inactive mode.

For example, one or more expected paging collisions can be determined for a first UE 10 at the terminal node 110 in radio inactive mode and at least a second UE 12 at the terminal node 110 in radio idle and/or radio inactive mode.

In examples, determining one or more expected paging collisions comprises determining one or more expected paging collisions that will occur between the first user equipment 10 at the terminal node 110 and the second user equipment 12 at the terminal node 110 when the first user equipment 10 is in radio inactive mode and the second user equipment 12 is in radio idle mode.

In examples, determining one or more expected paging collisions can be performed in any suitable way using any suitable method and any suitable information.

For example, any suitable information regarding expected paging cycles for a UE configuration at the terminal node 110 can be used. In examples, one or more identifiers associated with one or more UEs enabled at the terminal node 110 can be used.

In some examples, determining one or more expected paging collisions comprises using radio access network paging cycle information, which can be considered RAN-pagingcycle information.

For example, determining one or more expected paging collisions can comprise checking for paging collisions for RAN paging cycle configurations of radio inactive state of one or more UEs enabled at the terminal node 110.

For example, RAN paging cycle used by RAN when paging a UE in RRC_INACTIVE mode can take values of 32, 64, 128 or 256 radio frames. Determining one or more expected paging collisions can comprise checking paging collision possibility for the RAN paging cycles for RRC_INACTIVE state for a first UE, which can be associated with a first network, with RRC_IDLE mode paging occasions of a second UE, which can be associated with a second network.

In examples, in radio idle mode, such as RRC_IDLE mode, a paging collision can be avoided based on a change in identifier.

In some examples, when a UE is moving to radio inactive, such as RRC_INACTIVE, RAN can assign any of the possible RAN paging cycles. Accordingly, in examples, when resolving paging collision for radio idle, such as RRC_IDLE, and radio inactive, such as RRC_INACTIVE, states between subscriptions and/or USIMs and/or enabled UEs, RAN paging cycles of radio inactive, such as RRC_INACTIVE, can also be considered.

In some examples, determining one or more expected paging collisions can be performed based at least in part on the received at least one message. For example, determining one or more expected paging collisions can be caused by and/or triggered by and/or controlled by the one or more messages 20.

Accordingly, in some examples, method 200 comprises receiving at least one message 20 and determining one or more expected paging collisions based, at least in part, on the received at least one message 20.

At block 206, method 200 comprises determining assistance information 14, based, at least in part, on the determined one or more expected paging collisions.

In examples, assistance information 14 can be considered paging configuration assistance information 14 and/or paging cycle assistance information 14 and/or RAN-Paging cycle assistance information and/or paging collision avoidance assistance information 14 and so on.

Assistance information 14 can comprise any suitable information determined in any suitable way using any suitable method.

In examples, assistance information 14 comprises any suitable information to assist in determining paging configuration information 16.

In some examples, assistance information 14 comprises information configured to assist and/or to be used in avoiding one or more expected paging collisions that will occur between a first user equipment 10 and at least a second user equipment 12 of a multiple subscription device, such as the terminal node 110, when the first user equipment 10 and second user equipment 12 are not in radio connected mode and at least one of the first user equipment 10 and second user equipment 12 is in radio inactive mode.

In some examples, assistance information 14 comprises information configured to assist in avoiding and/or preventing one or more expected paging collisions that will occur between the first user equipment 10 at the terminal node 110 and at least the second user equipment 12 at the terminal node 110 when the first user equipment 10 is in radio inactive mode and the second user equipment 12 is in radio idle mode.

In examples, determining assistance information 14 comprises analyzing one or more determined expected paging collisions and determining information to avoid the one or more determined expected paging collisions.

In examples, the assistance information 14 comprises at least one of: an indication of one or more preferred paging cycles, one or more offsets and information configured to assist in modification of a user equipment identifier at the terminal node 110, which can be considered a device.

In examples, one or more preferred paging cycles can be/can be considered one or more preferred RAN paging cycles.

In examples, preferred paging cycle(s) can be considered paging cycles determined not to cause a paging collision to occur. Any suitable indication of one or more preferred paging cycles can be used.

In examples, the indication of one or more preferred paging cycles can be positive or negative in nature. That is, the indication can provide information regarding acceptable paging cycles or information regarding paging cycles that are to be avoided.

In some examples, one or more offsets can be considered one or more paging offsets and/or one or more timing offsets.

In examples one or more offsets can be provided to be applied to one or more paging cycles, such as one or more RAN paging cycles, to avoid one or more determined expected paging collisions.

For example, if it is determined that a relatively short paging cycle is to be used for the terminal node 110, and that use of such a paging cycle will cause one or more paging collisions to occur, one or more offsets can be provided to allow the paging cycles to be used while avoiding paging collision(s).

Shorter paging cycles can be used to meet, for example, paging latency requirements as part of quality-of-service requirements.

In some examples, one or more offsets are provided, as at least part of the assistance information 14, if it is determined at block 204 that all or some possible paging cycles will cause paging collisions to occur.

In examples, the one or more offsets can be positive or negative in nature. That is, the one or more offsets can provide information regarding acceptable offset(s) or information regarding offset(s) that are to be avoided.

Accordingly, in examples, the one or more offsets comprises one or more offsets to be avoided and/or more acceptable/suggested offsets.

In examples, any suitable information configured to assist in modification of a user equipment identifier at the terminal node 110 can be used.

For example, the information configured to assist in modification of a user equipment identifier at the terminal node 110 can comprise information at least indicative of one or more identifiers to be avoided and/or one or more acceptable identifiers.

In some examples, the network node comprises/is an access node 120, such as a gNB, and the assistance information 14 comprises an indication of one or more preferred paging cycles and/or one or more offsets.

In some examples, the network node comprises/is a core node 129 and the assistance information 14 comprises information configured to assist in modification of a user equipment identifier at the terminal node 110.

In examples, determining assistance information 14 comprises determining assistance information 14 based, at least in part, on information of one or more neighboring cells.

For example, the terminal node 110, and/or one or more UEs enabled at the terminal node 110, can identify one or more identifiers and/or one or more offsets considering future mobility. In examples, the terminal node 110, and/or one or more UEs enabled at the terminal node 110, has a set of neighbor cell system information stored and can use this neighbor cell system information in determining the assistance information 14.

In examples where it is determined that no paging collisions are expected, the assistance information 14 can comprise information indicating that no paging collision is expected.

At block 208, method 200 comprises transmitting the assistance information 14 to at least one network node.

In examples, block 208 can be considered to comprise causing and/or controlling transmission of the assistance information 14 to at least one network node.

From the point of view of the network node, which can be an access node 120 or a core node 129, block 208 comprises receiving the assistance information 14 as described herein.

The assistance information 14 can be transmitted in any suitable way using any suitable method.

In examples, transmitting the assistance information 14 comprises transmitting the assistance information 14 via at least one radio resource control (RRC) signaling message 18.

In some examples, transmitting the assistance information 14 comprises transmitting the assistance information 14 while the terminal node 110, and/or one or more UEs enabled at the terminal node 110, are in radio connected mode.

In examples, the network node comprises/is a core node 129. Accordingly, in examples, transmitting the assistance information 14 comprises transmitting the assistance information 14 to at least one core network node 129.

In some examples, transmitting the assistance information 14 comprises transmitting the assistance information 14 via at least one Non-Access Stratum (NAS) message.

At block 210, method 200 comprises determining paging configuration information 16 based, at least in part, on the received assistance information 14.

Paging configuration information 16 can have any suitable form and/or can comprise any suitable information.

In examples, paging configuration information comprises information to configure and/or allow configuration of paging at the terminal node 110 and/or one or more UEs enabled at the terminal node 110 to avoid paging collisions between the first UE 10 and the second UE 12 when the first and second UE 10, 12 are not in radio connected mode and at least one of the first and second UE 10, 12 are in radio inactive mode.

In examples, paging configuration information 16 comprises information at least indicative of one or more paging cycles to be used and/or configured at the terminal node 110 to avoid, at least, one or more paging collisions determined at block 204.

For example, the paging configuration information 16 can comprise information at least indicative of one or more RAN paging cycles to be used and/or to be configured at the terminal node 110.

In some examples, the paging configuration information 16 comprises information at least indicative of one or more offsets for use in configuring paging at the terminal node 110 to avoid, at least, one or more paging collisions determined at block 204.

In some examples, the paging configuration information 16 comprises RAN paging cycle and paging offset to be applied as part of suspend-configuration RRC-Connection-Release message.

In some examples, the paging configuration information 16 comprises information at least indicative of a one or more UE identifiers to be used by one or more UEs enabled at the terminal node 110 to avoid, at least, one or more paging collisions determined at block 204.

In examples, the paging configuration information 16 comprises information to assign one or more new identifiers to one or more UEs enabled at the terminal node 110.

The new identifiers can be selected to avoid paging collisions when used by the terminal node 110, and/or one or more UEs enabled at the terminal node 110, to determine a paging configuration to use based, at least in part, on the UE identifier(s).

In examples, paging configuration information 16 can be determined in any suitable way using any suitable method.

In examples, the network node analyses the assistance information 14 and determines paging configuration information 16 to configure and/or to allow configuration of paging at the terminal node 110 and/or one or more UEs enabled at the terminal node 110, to avoid, at least, one or more paging collisions determined at block 204.

For example, the network node can select a paging cycle and/or offset based, at least in part, on the assistance information 14 to avoid paging collisions at the terminal node 110.

For example, the network node can determine a UE identifier based, at least in part, on the assistance information 14 to avoid paging collisions at the terminal node 110.

At block 212, method 200 comprises transmitting the determined paging configuration information 16 to configure paging at the terminal node 110, which can be considered a multiple subscription device.

In examples, block 212 can be considered to comprise causing and/or controlling transmission of the determined paging configuration information 16 to configure paging at the terminal node 110, which can be considered a multiple subscription device.

Consequently, FIG. 2 illustrates a method 200 comprising:

receiving assistance information 14, the assistance information 14 comprising information configured to assist in avoiding one or more expected paging collisions that will occur between a first user equipment 10 and a second user equipment 12 of a multiple subscription device, when the first user equipment 10 and second user equipment 12 are not in radio connected mode and at least one of the first user equipment 10 and second user equipment 12 are in radio inactive mode;

determining paging configuration information 16 based, at least in part, on the received assistance information 14; and

transmitting the determined paging configuration information 16 to configure paging at the multiple subscription device.

From the point of view of the terminal node 110, block 212 comprises receiving paging configuration information 16, the paging configuration information 16 determined based, at least in part, on the assistance information 14.

Consequently, FIG. 2 illustrates a method 200 comprising:

enabling paging collision avoidance in a device with multiple subscriptions comprising at least a first subscription configured to enable a first user equipment 10 at the device and a second subscription configured to enable a second user equipment 12 at the device by:
determining one or more expected paging collisions that will occur between the first user equipment 10 at the device and at least the second user equipment 12 at the device when the first user equipment 10 and second user equipment 12 are not in radio connected mode and at least one of the first user equipment 10 and second user equipment 12 are in radio inactive mode;
determining assistance information 14, based, at least in part, on the determined one or more expected paging collisions;
transmitting the assistance information 14 to at least one network node; and
receiving paging configuration information 16, the paging configuration 16 information determined based, at least in part, on the assistance information 14.

The paging configuration information 16 can be transmitted in any suitable way using any suitable method.

In some examples, transmitting the determined paging configuration information 16 comprises transmitting paging configuration information 16 via a message configured to move a user equipment from radio connected mode to radio idle mode or radio inactive mode.

In some examples, transmitting the paging configuration information 16 comprises transmitting paging configuration information via an RRC-Connection-Release message.

In examples, transmitting the determined paging configuration information 16 comprises transmitting at least one user equipment identifier.

In some examples, paging in respect of one or more UEs enabled at the terminal node 110 is configured based, at least in part, on the received paging configuration information 16.

In some examples, method 200 comprises processing and/or applying, by the terminal node 110 and/or one or more UEs enabled at the terminal node 110, the received paging configuration information 16.

In some examples, method 200 comprises processing and/or applying, by the terminal node 110 and/or one or more UEs enabled at the terminal node 110, the received paging configuration information to configure paging of one or more UEs enabled at the terminal node 110 without one or more paging collisions determined at block 204.

Examples of the disclosure provide technical benefits. For example, examples of the disclosure provide for one or more determined paging collisions to be avoided between multiple subscriptions on a multi-subscription device when the device moves from a radio idle state to a radio inactive state, in an efficient way.

Examples provide for paging collisions to be avoided when a UE enabled at a multi-subscription device moves, for example, from radio idle to radio inactive without using additional signaling, such as additional NAS signalling.

Examples of the disclosure can be applied to any combination of radio idle and radio inactive modes across UEs enabled at a multi-subscription device.

Examples of the disclosure ensure that paging can occur across UEs enabled at a multi-subscription device when the reception configuration of the device is limited compared to the number of subscriptions and/or enabled UEs.

In examples, avoiding paging collision helps to avoid missed paging and paging repetition at the network.

FIG. 4 illustrates an example of a method 400.

In examples, the method 400 can be performed by any suitable apparatus comprising any suitable means for performing the method 400.

In examples, the method 400 can be performed by a terminal node 110, such as a MUSIM device.

Method 400 comprises enabling paging collision avoidance in a device with multiple subscriptions comprising at least a first subscription configured to enable a first user equipment 10 at the device and a second subscription configured to enable a second user equipment 12 at the device by performing the blocks illustrated in the example of FIG. 4.

At block 402, method 400 comprises determining one or more expected paging collisions that will occur between the first user equipment 10 at the device and at least the second user equipment 12 at the device when the first user equipment and second user equipment 10, 12 are not in radio connected mode and at least one of the first user equipment 10 and second user equipment 12 are in radio inactive mode.

At block 404, method 400 comprises determining assistance information 14, based, at least in part, on the determined one or more expected paging collisions.

At block 406, method 400 comprises transmitting the assistance information 14 to at least one network node.

At block 408, method 400 comprises receiving paging configuration information 16, the paging configuration information 16 determined, based, at least in part, on the assistance information 14.

Consequently, FIG. 4 illustrates a method 400 comprising:
enabling paging collision avoidance in a device with multiple subscriptions comprising at least a first subscription configured to enable a first user equipment 10 at the device and a second subscription configured to enable a second user equipment 12 at the device by:
determining one or more expected paging collisions that will occur between the first user equipment 10 at the device and at least the second user equipment 12 at the device when the first user equipment and second user equipment 10, 12 are not in radio connected mode and at least one of the first user equipment 10 and second user equipment 12 are in radio inactive mode;
determining assistance information 14, based, at least in part, on the determined one or more expected paging collisions;
transmitting the assistance information 14 to at least one network node; and
receiving paging configuration information 16, the paging configuration information 16 determined, based, at least in part, on the assistance information 14.

FIG. 5 illustrates an example of a method 500.

In examples, the method 500 can be performed by any suitable apparatus comprising any suitable means for performing the method 500.

In examples, the method 500 is performed by an access node 120 or a core node 129.

At block 502, method 500 comprises receiving assistance information 14, the assistance information 14 comprising information configured to assist in avoiding one or more expected paging collisions that will occur between a first user equipment 10 and at least a second user equipment 12 of a multiple subscription device, when the first user equipment 10 and second user equipment 12 are not in radio connected mode and at least one of the first user equipment 10 and second user equipment 12 are in radio inactive mode.

At block 504, method 500 comprises determining paging configuration information 16 based, at least in part, on the received assistance information 14.

At block 506, method 500 comprises transmitting the determined paging configuration information 16 to configure paging at the multiple subscription device.

Consequently, FIG. 5 illustrates a method 500 comprising:
receiving assistance information 14, the assistance information 14 comprising information configured to assist in avoiding one or more expected paging collisions that will occur between a first user equipment 10 and at least a second user equipment 12 of a multiple subscription device, when the first user equipment 10 and second user equipment 12 are not in radio connected mode and at least one of the first user equipment 10 and second user equipment 12 are in radio inactive mode;
determining paging configuration information 16 based, at least in part, on the received assistance information 14; and
transmitting the determined paging configuration information 16 to configure paging at the multiple subscription device.

FIG. 6 shows an example of avoiding paging collisions at a MUSIM device.

In the example of FIG. 6 a MUSIM device comprises a first USIM (USIM1) that enables a first UE (UE-1) 110a and a second USIM (USIM2) that enables a second UE (UE-2) 110b.

In the illustrated example, separate lines are presented to indicate actions at UE-1 and UE-2, although the UEs are enabled at one device.

Also represented in the example of FIG. 6 is a gNB associated with UE-1 and network 1 (NTWK1) and a gNB associated with UE-2 and network 2 (NTWK2) which, in the example of FIG. 6, is different to NTWK1.

At block 602, UE1 is in RRC_IDLE mode.

At block 604, UE2 is in RRC_IDLE mode.

At block 606 RRC connection setup is performed between UE1 and gNB1.

At block 608, UE1 checks potential paging collisions for RRC_INACTIVE for all or some possible RAN cycles.

At block 610, if collision can be avoided for some cycles, these cycles are selected as preferred RAN cycles.

At block 612, If collision cannot be avoided UE1 suggests offset the RAN cycle to avoid collision.

At block 614 an RRC message is transmitted from UE1 to gNB1. The RRC message includes RAN-Cycle-Preference and Cycle-specific-offset-list.

At block 616 an RRC-Connection-Release message is transmitted from gNB1 to UE1. The RRC-Connection-Release message comprising suspend Config including RAN-Paging-cycle selected as per preference and paging-offset.

At block 618 UE1 is in RRC_INACTIVE mode with paging collision avoided with UI-RRC-Active

At block 620 UE2 remains in RRC_IDLE.

FIG. 6 illustrates a signalling diagram according to some, but not necessarily all, examples.

In FIG. 6, UE1, while being in connected mode, identifies the possibility of paging collision after it moves to RRC_INACTIVE and informs its network (gNB-1) a preferred RAN-Paging Cycle. It may also indicate a list of cycle specific offsets when all or some of the paging cycles can lead to collision.

In examples, cycle specific offset list may be provided if the RAN cycle selected for avoiding collision is not optimal from a power saving perspective.

GNB-1 selects RAN-Paging Cycle or RAN-paging offset and informs the UE in RRC Release message along with suspend config.

FIG. 7 illustrates an example of a method 700.

In examples, the method 700 can be performed by any suitable apparatus comprising any suitable means for performing the method 700.

In examples, the method 700 is performed by a MUSIM device comprising a first USIM (USIM1) and a second USIM (USIM2) having associated identifiers (GUTI1, GUTI2).

USIM1 is associated with a first network (NTWK1) and USIM2 is associated with a second network (NTWK2).

At block 702, USIM 1 identifies the paging collision(s) for its own GUTI and GUTI of USIM2 based on idle mode parameters of NTWK1 and NTWK2.

At block 704, USIM1 identifies the paging collision(s) for its own GUTI and GUTI of USIM2 for possible RAN-cycles of RRC_INACTIVE and RRC_IDLE of USIM2.

At block 706, USIM1 derives assistance information 14 for GUTI as UE-ID value to be avoided based on the above.

At block 708, USIM1 sends the assistance information 14 as part of NAS message for GUTI reallocation.

At block 710, network assigns new GUTI resolving the collision for IDLE-IDLE and INACTIVE-IDLE states possible later.

FIG. 7 illustrates an example which helps for paging collision avoidance for both RRC_INACTIVE and RRC_IDLE.

In this example, both USIM-1 and USIM-2 are in 5GS.

USIM-1 identifies the paging collision for its own GUTI and GUTI of USIM2 based on idle mode parameters for NTWK-1 and NTWK-2. USIM1 then derives the assistance information about UE-IDs to be avoided, considering above two blocks and informs the core network.

Core network assigns the new GUTI which can resolve the idle-idle and idle-inactive.

It is also possible that one of the USIMs, for example USIM-1, is camped to EPS. USIM-1 can also send NAS message to request for paging collision avoidance.

Even here, USIM-1 derives the assistance information considering both idle and inactive case of USIM-2 and sends the assistance information to MME. Assistance information could be a list of offsets to be avoided.

In some examples, UE may also identify the UE-IDs/offsets to be avoided considering future mobility. For example, if it has a set of neighbour cell system information stored, UE could identify the UE-IDs or offsets to be avoided considering the mobility and inform the core network in block 708.

This example is also applicable for NTWK-1 as LTE network. In this case the algorithm checks paging collision based on IMSI of IDLE mode NTWK and GUTI of NR-NTWK in RRC_INACTIVE state.

FIG. 8 shows an example of avoiding paging collisions at a MUSIM device.

In the example of FIG. 8 a MUSIM device comprises a first USIM (USIM1) that enables a first UE (UE-1) 110a and a second USIM (USIM2) that enables a second UE (UE-2) 110b.

In the illustrated example, separate lines are presented to indicate actions at UE-1 and UE-2, although the UEs are enabled at one device.

Also represented in the example of FIG. 8 is a core node 129a/AMF associated with UE-1 and network 1 (NTWK1) and a core node 129b/AMF associated with UE-2 and network 2 (NTWK2) which, in the example of FIG. 8, is different to NTWK1.

At block 802, UE1 is in RRC_IDLE mode.

At block 804, UE2 is in RRC_IDLE mode.

At block 806, UE1 checks for paging collisions for UE1 and UE2 in RRC_IDLE state. That is, at block 806, UE1 checks for paging collisions for IDLE-IDLE state of UE 1 and UE2.

At block 808, UE 1 checks for paging collisions for INACTIVE-IDLE state combinations of UE1 and UE2.

At block 810, UE1 determines and/or generates assistance information 14 common for IDLE-IDLE and IDLE-INACTIVE state combinations for UE1 and UE2.

At block 812, a NAS signaling message is transmitted from UE1 to AMF1, the NAS signaling message comprising the determined assistance information 14.

At block 814, AMF 1 reallocates GUTI of UE1 based on the assistance information 14.

Examples of the disclosure provide technical benefits. For example, examples of the disclosure provide for anticipation and avoidance of paging collisions when a UE of a multi-subscription device moves from radio idle mode to radio connected mode in an efficient way.

FIG. 9A illustrates an example of a controller 1130. The controller 1130 can be used in an apparatus such as a network node 110, 120, 129 such as a mobile terminal or UE and/or a gNB. In examples, controller 1130 can be considered an apparatus 1130.

Implementation of a controller 1130 may be as controller circuitry. The controller 1130 may be implemented in hardware alone, have certain aspects in software including firmware alone or can be a combination of hardware and software (including firmware).

As illustrated in FIG. 9A the controller 1130 may be implemented using instructions that enable hardware functionality, for example, by using executable instructions of a computer program 1136 in a general-purpose or special-purpose processor 1132 that may be stored on a computer readable storage medium (disk, memory etc.) to be executed by such a processor 1132.

The processor 1132 is configured to read from and write to the memory 1134. The processor 1132 may also comprise an output interface via which data and/or commands are output by the processor 1132 and an input interface via which data and/or commands are input to the processor 1132.

The memory 1134 stores a computer program 1136 comprising computer program instructions (computer program code) that controls the operation of the apparatus when loaded into the processor 1132. The computer program instructions, of the computer program 1136, provide the logic and routines that enables the apparatus to perform the methods illustrated in FIGS. 2 and/or 4 and/or 5 and/or 6 and/or 7 and/or 8. The processor 1132 by reading the memory 1134 is able to load and execute the computer program 1136.

The apparatus therefore comprises:

at least one processor 1132; and
at least one memory 1134 including computer program code
the at least one memory 1134 and the computer program code configured to, with the at least one processor 1132, cause the apparatus at least to perform:
enabling paging collision avoidance in a device with multiple subscriptions comprising at least a first subscription configured to enable a first user equipment at the device and a second subscription configured to enable a second user equipment at the device by:
determining one or more expected paging collisions that will occur between the first user equipment at the device and at least the second user equipment at the device when the first user equipment and second user equipment are not in radio connected mode and at least one of the first user equipment and second user equipment are in radio inactive mode;
determining assistance information, based, at least in part, on the determined one or more expected paging collisions;
transmitting the assistance information to at least one network node; and
receiving paging configuration information, the paging configuration information determined based, at least in part, on the assistance information.

The apparatus therefore comprises:

at least one processor 1132; and
at least one memory 1134 including computer program code
the at least one memory 1134 and the computer program code configured to, with the at least one processor 1132, cause the apparatus at least to perform:
receiving assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determining paging configuration information based, at least in part, on the received assistance information; and
transmitting the determined paging configuration information to configure paging at the multiple subscription device.

As illustrated in FIG. 9A, the computer program 1136 may arrive at the apparatus via any suitable delivery mechanism 1162. The delivery mechanism 1162 may be, for example, a machine-readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1136. The delivery mechanism may be a signal configured to reliably transfer the computer program 1136. The apparatus may propagate or transmit the computer program 1136 as a computer data signal.

Computer program instructions for causing an apparatus to perform at least the following or for performing at least the following:

enabling paging collision avoidance in a device with multiple subscriptions comprising at least a first subscription configured to enable a first user equipment at the device and a second subscription configured to enable a second user equipment at the device by:
determining one or more expected paging collisions that will occur between the first user equipment at the device and at least the second user equipment at the device when the first user equipment and second user equipment are not in radio connected mode and at least one of the first user equipment and second user equipment are in radio inactive mode;
determining assistance information, based, at least in part, on the determined one or more expected paging collisions;
transmitting the assistance information to at least one network node; and
receiving paging configuration information, the paging configuration information determined based, at least in part, on the assistance information.

Computer program instructions for causing an apparatus to perform at least the following or for performing at least the following:

receiving assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determining paging configuration information based, at least in part, on the received assistance information; and
transmitting the determined paging configuration information to configure paging at the multiple subscription device.

The computer program instructions may be comprised in a computer program, a non-transitory computer readable medium, a computer program product, a machine-readable medium. In some but not necessarily all examples, the computer program instructions may be distributed over more than one computer program.

Although the memory 1134 is illustrated as a single component/circuitry it may be implemented as one or more separate components/circuitry some or all of which may be integrated/removable and/or may provide permanent/semi-permanent/dynamic/cached storage.

In examples the memory 1134 comprises a random-access memory 1158 and a read only memory 1160. In examples the computer program 1136 can be stored in the read only memory 1158. See, for example, FIG. 9B

In some examples the memory 1134 can be split into random access memory 1158 and read only memory 1160.

Although the processor 1132 is illustrated as a single component/circuitry it may be implemented as one or more separate components/circuitry some or all of which may be integrated/removable. The processor 1132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2 and/or 4 and/or 5 and/or 6 and/or 7 and/or 13 and/or 8 may represent steps in a method and/or sections of code in the computer program 1136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus can, in examples, comprise means for:
enabling paging collision avoidance in a device with multiple subscriptions comprising at least a first subscription configured to enable a first user equipment at the device and a second subscription configured to enable a second user equipment at the device by:
determining one or more expected paging collisions that will occur between the first user equipment at the device and at least the second user equipment at the device when the first user equipment and second user equipment are not in radio connected mode and at least one of the first user equipment and second user equipment are in radio inactive mode;
determining assistance information, based, at least in part, on the determined one or more expected paging collisions;
transmitting the assistance information to at least one network node; and
receiving paging configuration information, the paging configuration information determined based, at least in part, on the assistance information.

Thus, the apparatus can, in examples, comprise means for:
receiving assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determining paging configuration information based, at least in part, on the received assistance information; and
transmitting the determined paging configuration information to configure paging at the multiple subscription device.

In examples, an apparatus can comprise means for performing one or more methods, and/or at least part of one or more methods, as disclosed herein.

In examples, an apparatus can be configured to perform one or more methods, and/or at least part of one or more methods, as disclosed herein.

The above described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-27. (canceled)

28. A device, comprising at least one processor, and at least one memory including computer program code, wherein the at least one memory and the computer program code are configured, with the at least one processor, to cause the device to:
enable paging collision avoidance in a device with multiple subscriptions comprising at least a first subscription configured to enable a first user equipment at the device and a second subscription configured to enable a second user equipment that further causes the device to:
determine one or more expected paging collisions that will occur between the first user equipment at the device and at least the second user equipment at the device when the first user equipment and second user equipment are not in radio connected mode and at least one of the first user equipment and second user equipment are in radio inactive mode;
determine assistance information, based, at least in part, on the determined one or more expected paging collisions;
transmit the assistance information to at least one network node; and
receive paging configuration information, the paging configuration information determined based, at least in part, on the assistance information.

29. The device as claimed in claim 28, wherein determining one or more expected paging collisions comprises the device caused to determine, one or more expected paging collisions that will occur between the first user equipment at the device and the second user equipment at the device when the first user equipment is in radio inactive mode and the second user equipment is in radio idle mode.

30. The devices claimed in claim 28, wherein determining one or more expected paging collisions comprises the device caused to use radio access network paging cycle information.

31. The device as claimed in claim 28, wherein the assistance information comprises at least one of: an indication of one or more preferred paging cycles, one or more offsets and information configured to assist in modification of a user equipment identifier at the device.

32. The device as claimed in claim 28, wherein transmitting the assistance information comprises the device caused to transmit the assistance information via at least one radio resource control signaling message.

33. The device as claimed in claim 28, wherein receiving paging configuration information comprises the device caused to receive paging configuration information via a message configured to move a user equipment from radio connected state to radio idle state or radio inactive state

34. The device as claimed in claim 28, wherein transmitting the assistance information comprises the device caused to transmit the assistance information to at least one core network node.

35. The device as claimed in claim 28, wherein receiving paging configuration information comprises the device caused to receive at least one user equipment identifier.

36. The device as claimed in claim 28, is further configured to:
receive at least one message, wherein determining one or more expected paging collisions comprises determining one or more expected paging collisions based, at least in part, on the received at least one message.

37. The device as claimed in claim 28, wherein determining assistance information comprises the device caused to determine assistance information based, at least in part, on information of one or more neighboring cells.

38. A network node, comprising at least one processor, and at least one memory including computer program code, wherein the at least one memory and the computer program code are configured, with the at least one processor, to cause the network node to:
receive assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determine paging configuration information based, at least in part, on the received assistance information; and
transmit the determined paging configuration information to configure paging at the multiple subscription device.

39. The network node as claimed in claim 38, wherein the assistance information comprises information configured to assist in avoiding one or more expected paging collisions that will occur between the first user equipment at the device and at least the second user equipment at the device when the first user equipment is in radio inactive mode and the second user equipment is in radio idle mode.

40. The network node as claimed in claim 38, wherein the assistance information comprises at least one of: an indication of one or more preferred paging cycles, one or more offsets and information configured to assist in modification of a user equipment identifier at the device.

41. The network node as claimed in claim 38, wherein receiving the assistance information comprises receiving the assistance information via at least one radio resource control signaling message.

42. The network node as claimed in claim 38, wherein transmitting the determined paging configuration information comprises transmitting paging configuration information via a message configured to move a user equipment from radio connected mode to radio idle mode or radio inactive mode.

43. The network node as claimed in claim 38, wherein the apparatus is located at a core network node.

44. The network node as claimed in claim 38, wherein transmitting the determined paging configuration information comprises transmitting at least one user equipment identifier.

45. A computer program comprising instructions for causing a device to perform at least the following:
receiving assistance information, the assistance information comprising information configured to assist in avoiding one or more expected paging collisions that will occur between a first user equipment and at least a second user equipment of a multiple subscription device, when the first user equipment and second user equipment are not in radio connected mode and at least one of the first user equipment and second user equipment are in radio inactive mode;
determining paging configuration information based, at least in part, on the received assistance information; and
transmitting the determined paging configuration information to configure paging at the multiple subscription device.
